(19) United States
(12) Patent Application Publication
(10) Pub. No.: US 2024/0248999 A1
(43) Pub. Date: Jul. 25, 2024

(54) SYSTEMS AND METHODS FOR INTERFACING WITH SERVICE INFRASTRUCTURE

(71) Applicant: Verizon Patent and Licensing Inc., Basking Ridge, NJ (US)

(72) Inventors: Srithar Kaliappan, Tamil Nadu (IN); Sanjiv S. Gulshan, Morristown, NJ (US); Sravanth Devi, Tamil Nadu (IN); Shaji P. Selvaraj, Tamil Nadu (IN)

(21) Appl. No.: 18/157,301

(22) Filed: Jan. 20, 2023

(51) Int. Cl. G06F 21/60; G06F 21/31

(52) U.S. Cl. CPC G06F 21/602; G06F 21/31

(57) ABSTRACT

An example method includes receiving a query comprising a first identifier of a first entity at a portal interface controlled by a second entity. The first entity is validated based on the first identifier to generate a validated first entity. A first credential is generated based on the validated first entity and a second identifier generated by the second entity for the first entity. The first credential is sent to the first entity. Service request data is sent to the first entity. An order request associated with the service request data and a second credential is received at the portal interface. Responsive to validating that the second credential matches the first credential, an order response corresponding to the order request is sent.

### BACKGROUND

Large entities commonly use multiple data systems to allow customers to access offered services. For example, a customer may log directly in to a website managed by the large entity to order a product. Alternatively, a customer may use a web portal not controlled by the large entity that interfaces with the website to complete service requests.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram of a communication system environment in which some embodiments may be implemented.

FIGS. 2A, 2B, and 2C are diagrams of message flows for interfacing with applications through a portal interface, according to some embodiments.

FIG. 3 a diagram of a user interface, according to some embodiments.

FIG. 4 is a flow chart illustrating an example method for interfacing with applications through a portal interface, according to some embodiments.

FIG. 5 is an illustration of a scenario involving various examples of transmission mediums that may be used to communicatively couple computers and clients, according to some embodiments.

FIG. 6 is an illustration of a scenario involving an example configuration of a computer that may utilize and/or implement at least a portion of the techniques presented herein, according to some embodiments.

FIG. 7 is an illustration of a scenario involving an example configuration of a client that may utilize and/or implement at least a portion of the techniques presented herein, according to some embodiments.

FIG. 8 is an illustration of a scenario featuring an example non-transitory machine readable medium, according to some embodiments.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

In some instances, an entity, such as a service provider, may implement multiple interfaces to allow users to access offered services. A portal interface may provide facilities to accommodate user access through multiple access types. For example, the portal interface may provide a facility to allow a user to access the service provider system directly. In another example, the portal interface may provide a facility to allow the user to access a service provider system through an aggregation facility provided by another service provider. The portal interface provides credential processing to enable the access to the requested service provider, such as for initial access and later access requests that may be associated with an authenticated session.

One or more embodiments described herein may include a method. Such a method includes receiving a query having a first identifier of a first entity at a portal interface controlled by a second entity, validating the first entity based on the first identifier to generate a validated first entity, generating a first credential based on the validated first entity and a second identifier generated by the second entity for the first entity, sending the first credential to the first entity, sending service request data to the first entity, receiving at the portal interface an order request associated with the service request data and a second credential at the portal interface, and responsive to validating that the second credential matches the first credential, sending an order response corresponding to the order request.

One or more embodiments described herein may include a communication system. Such a system includes a portal interface that has a routing module configured to receive a query having a first identifier of a first entity, a validation module configured to validate the first entity based on the first identifier to generate a validated first entity, and a credential generation module configured to generate a first credential based on the validated first entity and a second identifier generated by a second entity for the first entity, wherein the routing module is configured to send the first credential to the first entity, send service request data to the first entity, and receive at the portal interface an order request associated with the service request data and a second credential at the portal interface, the credential generation module is configured to validate that the second credential matches the first credential, and the routing module is configured to, responsive to the credential generation module validating that the second credential matches the first credential, send an order response corresponding to the order request.

One or more embodiments described herein may include a non-transitory computer-readable medium storing instructions thereon that when executed by a processor cause the processor to receive a query having a first identifier of a first entity at a portal interface controlled by a second entity, validate the first entity based on the first identifier to generate a validated first entity, generate a first credential based on the validated first entity and a second identifier generated by the second entity for the first entity, send the first credential to the first entity, send service request data to the first entity, receive at the portal interface an order request generated based on the service request data and a second credential at the portal interface, and responsive to validating that the second credential matches the first credential, send an order response corresponding to the order request.

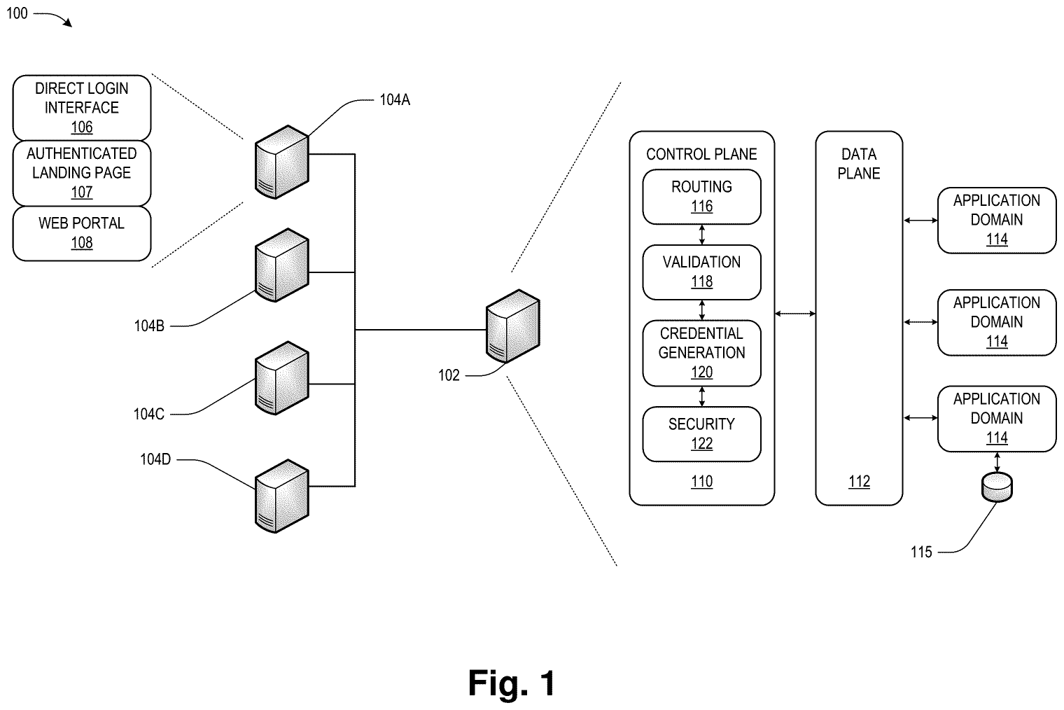

FIG. 1 is a diagram of an example communication system environment 100 that may be useful for illustrating the implementation of some embodiments. The communication system 100 comprises a portal interface 102 communicating with independent systems 104A, 104B, 104C, 104D. The portal interface 102 may be implemented on a server, workstation, cloud computing service, or some other processing resource, which may be controlled by a service provider. Each system 104A, 104B, 104C, 104D may be implemented on one or more servers, workstations, cloud computing services, or some other processing resource managed by separate enterprises. Users associated with the enterprises operating the systems 104A, 104B, 104C, 104D may use the portal interface 102 to obtain access to one or more services offered by the service provider, as further described herein. In some embodiments, the users may access the portal interface using a direct login interface 106 controlled by the service provider, an authenticated landing page 107 operated by the enterprise and/or the service provider, or a web portal 108 operated by an aggregation facility.

The web portal 108 may allow users to access the services provided by multiple service provider systems (including the service provider that is implementing the portal interface 102). Systems that provide these types of aggregation facilities are often referred to as “punchout” systems. Example punchout systems at the time of this application include ARIBA, HUBSPAN, ISOFT, or other similar systems.

According to some embodiments, the portal interface 102 implements routing, authentication, and/or security services for interactions between users and a service provider system that may include one or more applications. The portal interface 102 may include a control plane 110 that interfaces with a data plane 112. The data plane 112 may provide a switching fabric to enable communications between the control plane 110 and application domains 114. The portal interface 102 may communicate with one or more application domains 114 that may include the one or more applications. The applications may provide user interfaces that allow entity users to request and/or receive services. The application domains 114 may manage one or more data stores 115 for storing data regarding offered products and services, users, customer entities, and transactions. The example control plane 110 includes a routing module 116, a validation module 118, a credential generation module 120, and a security module 122. Although the routing module 116, the validation module 118, the credential generation module 120, and the security module 122 are illustrated as separate modules, the functionalities of the modules may be integrated into less modules or implemented using more modules.

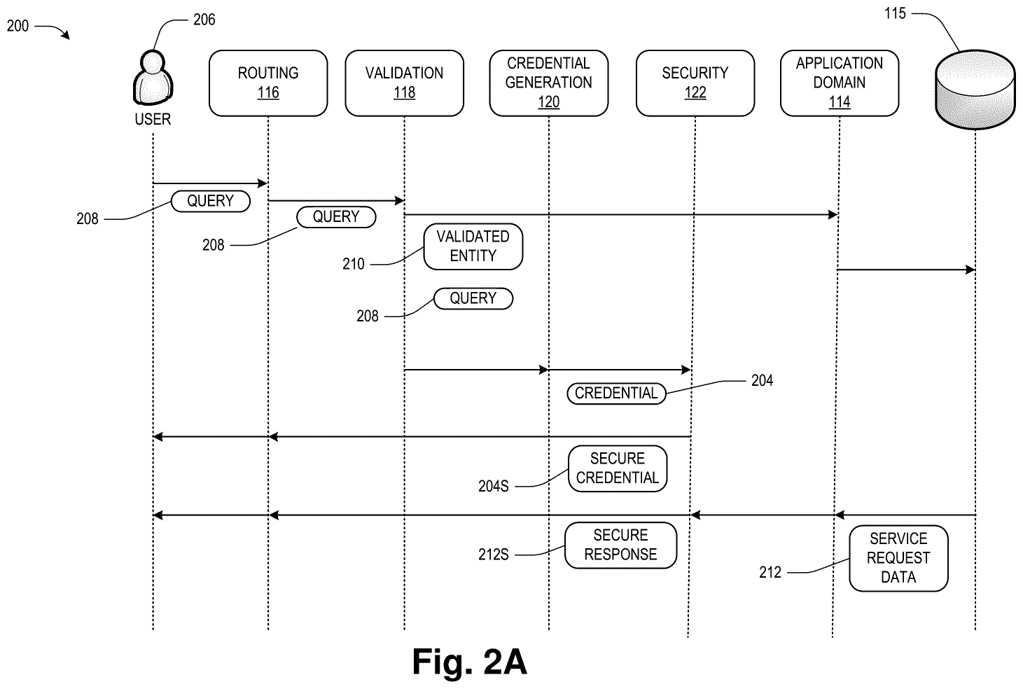

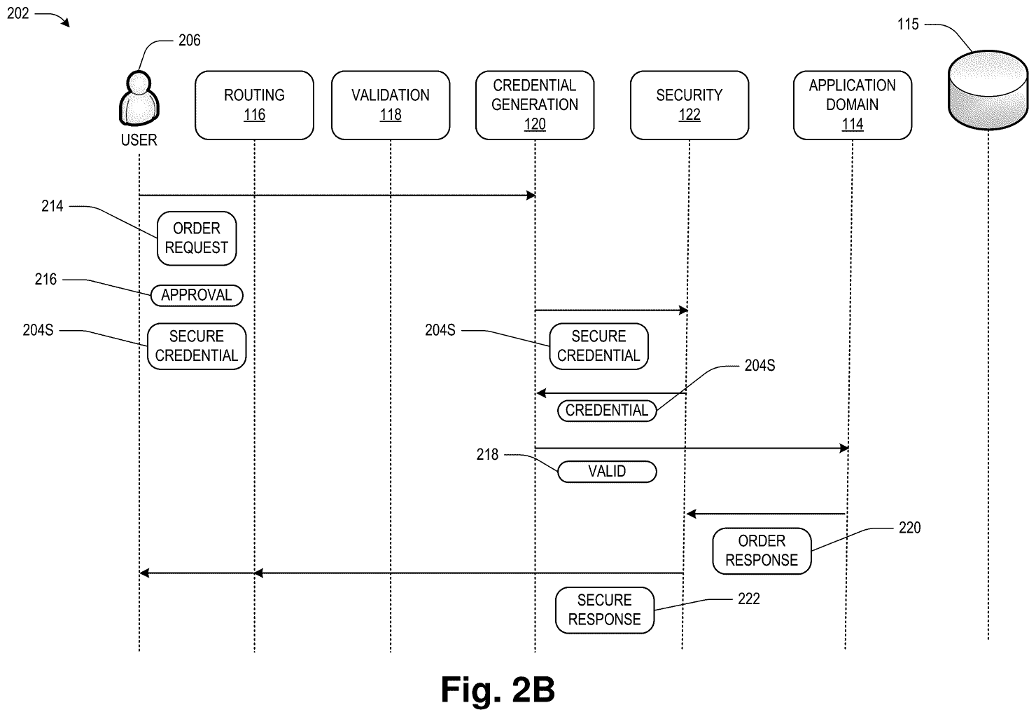

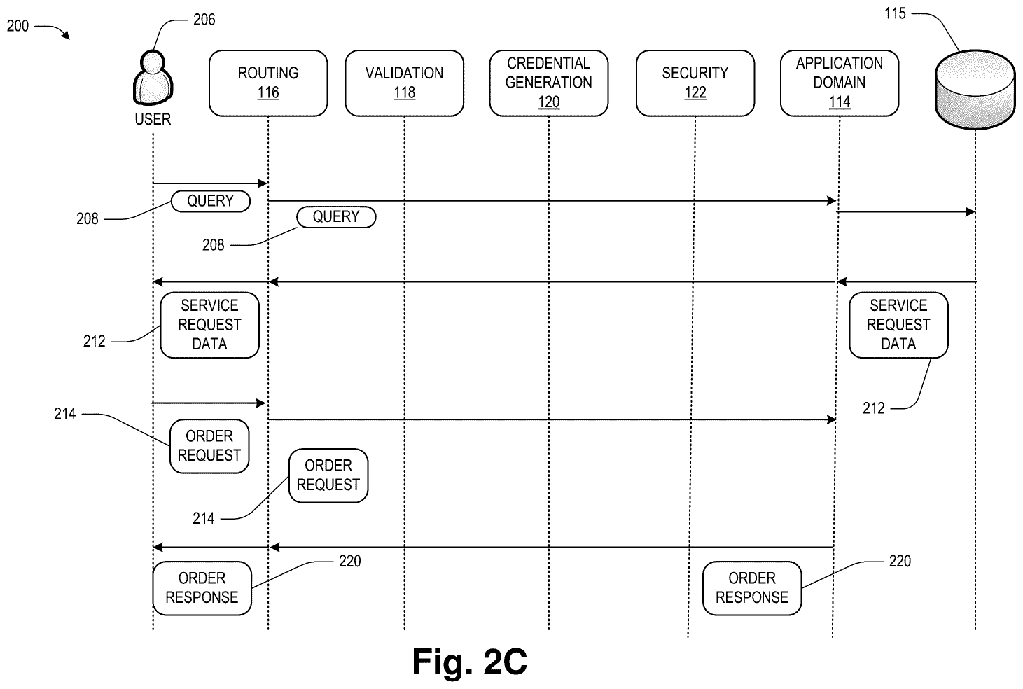

FIGS. 2A, 2B, and 2C are diagrams of potential example message flows 200, 202, 203 for using the portal interface 102, according to some embodiments. The message flows 200, 202, 203 of FIGS. 2A, 2B, and 2C are directed to providing user access to a service provider through the portal interface 102. In the example of FIG. 2A, a user submits a query 208 through the web portal 108. Referring to the message flow 200 of FIG. 2A, a user 206 generates a query 208 associated with a service request. In some embodiments, the query 208 comprises a customer entity public identifier, such as a Dun & Bradstreet identifier (DUNS ID), a network identifier, such as an IP address of the system 104A, 104B, 104C, 104D employed by the user 206, a user identifier, a query type indicating what services the user 206 is requesting, and a query address, such as a uniform resource locator (URL) referencing the services requested. In some implementations, the web portal 108 may generate (through specified mappings or identifiers) the query address based, for example, on the query type. The query 208 is routed to and received at the portal interface 102.

In some instances, the query address included in the query 208 is invalid. For example, web portal 108 may have generated a query address based on out-of-date mappings/identifiers. As another example, a user 206 may have saved the query address used for a previous request, and reused it for the current request. This query address may no longer be current within the service provider's system. For example, the query address may target a particular location within an application domain 114, which may have been modified by the service provider. Rather than generating an error due to an invalid query address, the portal interface 102 (through the routing module 116) replaces the query address with a redirect query address corresponding to the modified resource location in the application domain 114. For example, the routing module 116 may include a routing table that maps previously used addresses to current addresses. In this manner, the service provider may maintain configuration control and modify the application domain 114 while providing a seamless experience to the user 206. The user need not be aware of the modification and the web portal 108 need not be modified due to service provider modifications.

The validation module 118 receives the query 208 and validates the user 206 to verify the correct customer entity. In some embodiments, the validation module 118 evaluates the customer entity public identifier and the network identifier to validate that the query 208 has been sent from an authorized location. For example, the validation module 118 may store a table of customers indexed by the customer entity public identifier and ranges of network addresses associated with the customer entity. If the network identifier does not correspond to an allowed address for the customer entity associated with the customer entity public identifier, the validation module 118 rejects the query 208, and the portal interface 102 indicates a failure to the user 206. If the network identifier does correspond to an allowed address for the customer entity associated with the customer entity public identifier, the validation module 118 generates a validated entity 210, such as a flag, indicating that the query 208 has been authenticated. In some embodiments, the validation module 118 verifies that the query type is valid for the validated entity. If the query type is not authorized, the query 208 is rejected.

The validation module 118 passes the query 208 associated with the validated entity 210 to the resource in the application domain 114 targeted by the redirect address. The resource in the application domain 114 may then process the service request. In some implementations the resource may access the data store 115 to retrieve service request data 212 associated with the query 208. In one example, the query type in the query 208 may indicate that the service request relates to a mobile device, such as a smartphone, and the service request data 212 includes information regarding the devices the user 206 is authorized to request. In some embodiments, the user identifier in the query 208 is used to filter the items in the service request data 212 based on the role of the user 206. For example, the devices in the service request data 212 may be filtered such that only devices within a predetermined price range are selected. In some embodiments, the actual list of services that may be obtained is not sent to the user 206, but rather, the service request data 212 is a custom link address, such as a URL, that references the list of services associated with the service request. The list may be managed by the application domain 114 and stored in the data store 115 at a location corresponding to the link address.

Responsive to the validation module 118 identifying the validated entity 210, the validation module 118 signals the credential generation module 120 to generate a credential 204 for the user 206 that provides security for subsequent message exchanges sent by the user 206, such as a selection associated with a service request or authorization to execute the service. The credential 204 may have a limited duration such that is expires after a predetermined period of time. In some embodiments, the credential is generated based on user data associated with the user 206 and/or the customer entity and data maintained by the service provider. Example user fields that may be included in the credential include the customer entity public identifier (DUNS ID), the network identifier, the user identifier, or some other user data. Example service provider fields include a unique private customer identity identifier (i.e., not public), a random number, or other service provider data.

In some embodiments, the security module 122 provides encryption and decryption services for the portal interface 102. The credential generation module sends the credential to the security module 122 for encryption. The security module 122 encrypts the credential 204 to generate a secure credential 204S, and the service request data 212 may be encrypted to generate a secure response 212S. For example, where the service request data 212 includes a custom link address to a list of available services, the custom link address may be encrypted as part of the secure response. The routing module 116 sends the secure credential 204S and the secure response 212S to the system 104A, 104B, 104C, 104D employed by the user 206 at the customer entity. In some embodiments, the security module 122 employs an elliptic curve cryptography (ECC) cryptographic technique, an asymmetric key encryption algorithm using a public key for encryption and a private key for decryption.

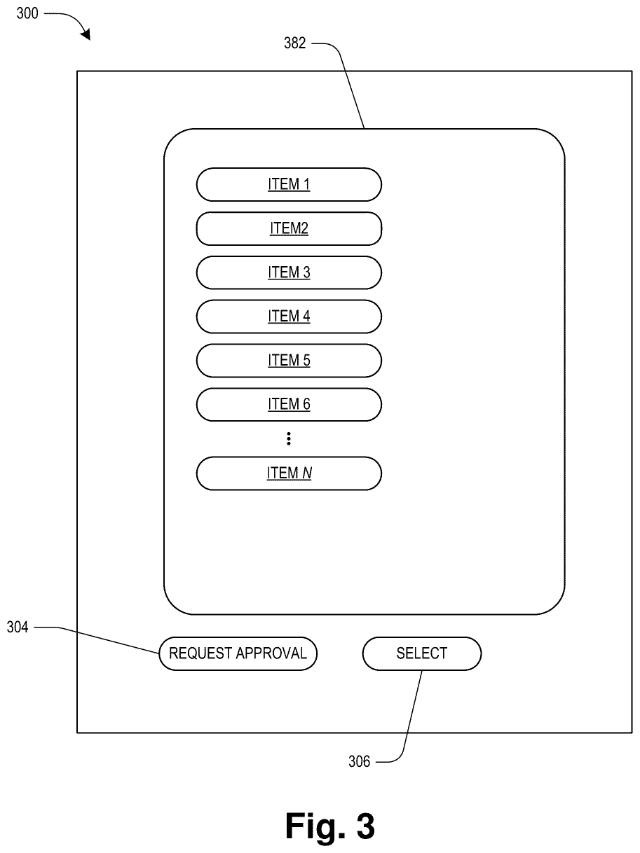

FIG. 3 is a diagram of an example user interface 300 that may be provided based on service request data, according to some embodiments. The displayed data may include a service request list 302 indicating the devices or services that may be selected by the user, a request approval control 304 and a select control 306. Other structures and configurations of the user interface 300 are within the scope of the present disclosure. In some implementations, the user 206 may employ the custom link address from the secure response 212S to provide the list of available services, and the data retrieved from the link is displayed on the user interface 300.

In some embodiments, the user 206 may be required to get approval for the selection associated with the service request. For example, the web portal 108 may provide facilities to handle an approval process for service requests. Prior to allowing the user 206 to complete a service request, the web portal 108 may access approval data for the customer entity to determine whether a user 206 needs approval and individuals authorized to grant the approval. The user 206 may activate the request approval control 304 after a selection associated with a service request, such as ITEM2, and the web portal 108 may contact the approving individual to seek the approval. In some embodiments, the select control 306 may be deactivated until the approval is received.

A user may select an available service and issue an “order” to request the service. Referring to the message flow 202 of FIG. 2B, the web portal 108 sends an order request 214, an approval indicator 216 (if necessary, as noted above), and the secure credential 204S to the portal server 102. The portal interface 102 may use the credential generation module 120 to validate the secure credential. For example, the credential generation module 120 may send the secure credential 204S to the security module 122 for decryption and receive back the credential 204, which allows the credential generation module 120 to verify the credential 204. Other verification processes may alternatively be used. Assuming the credential is determined to be valid, the credential generation module 120 sends a valid transaction flag 218 to the designated resource in application domain 114 (either in combination with the order request 214, or as part of a separate message). The designated resource in application domain 114 may then perform a process to execute (or authorize the execution of) the service. The resource in application domain 114 may provide an order response 220. The order response 220 may include service order related data (e.g., a status). In some implementations, the service order related data may include an order link (e.g., URL) which allows a user to access information associated with the requested service. The designated resource in application domain 114 sends the order response 220 to the security module 122 for encryption. A secure order message 222 is then sent by the routing module 116 to the user 206.

The portal interface 102 also allows interoperation of access to service provider services with direct login processes that do not use a web portal 108. Referring to the message flow 203 of FIG. 2C, a user 206 generates a query 208 through the direct login interface 106 or authenticated landing page 107 associated with a service request. The direct login interface 106 may be an interface in which the user logs into a website of the service provider using identification and authentication information managed by the service provider. The authenticated landing page 107 may be an interface in which the user logs into a website of the entity associated with the user (e.g., an enterprise), which itself has an interface to the service provider system (e.g., through a web API, federated authentication service, etc.). In some embodiments, the query 208 comprises a user identifier, a query type indicating what services the user 206 is requesting, and a query address, such as a uniform resource locator (URL) referencing the services requested. The query is sent by the user system to the portal interface 102.

The query 208 is received by the portal interface 102. The portal interface 102 may identify that the query 208 is received through a direct login or authenticated landing page, and given the previous authentication, bypass validation and credential generation (such as described above for FIGS. 2A and 2B). The routing module 116 may route the query 208 directly to the appropriate application domain 114 for the query (including any redirection necessitated by resource relocation). The resource in the application domain 114 may then process the service request. In some implementations the resource may access the data store 115 to retrieve service request data 212 associated with the query 208. In one example, the query type in the query 208 may indicate that the service request relates to a mobile device, such as a smartphone, and the service request data 212 includes information regarding the devices the user 206 is authorized to request. In some embodiments, the user identifier in the query 208 is used to filter the items in the service request data 212 based on the role of the user 206. For example, the devices in the service request data 212 may be filtered such that only devices within a predetermined price range are selected. In some embodiments, the actual list of services that may be obtained is not sent to the user 206, but rather, the service request data 212 is a custom link address, such as a URL, that references the list of services associated with the service request. The list may be managed by the application domain 114 and stored in the data store 115 at a location corresponding to the link address.

The application domain 114 may send a query response including the service request data 212 towards the user 206 by sending the service request data 212 to the system 104A, 104B, 104C, 104D employed by the user 206 at the customer entity. The user may then make an order request 214 through the portal interface 102. Again, since the direct login interface 106 or authenticated landing page 107 is already authenticated, the routing module 116 may bypass the validation module 118 and the credential generation module 120 and sends the order request 214 to the designated resource in application domain 114, which executes the transaction and generates an order response 220 for the order (which may include an order link to access order information). The routing module 116 sends the order response 220 to the system 104A, 104B, 104C, 104D employed by the user 206 at the customer entity

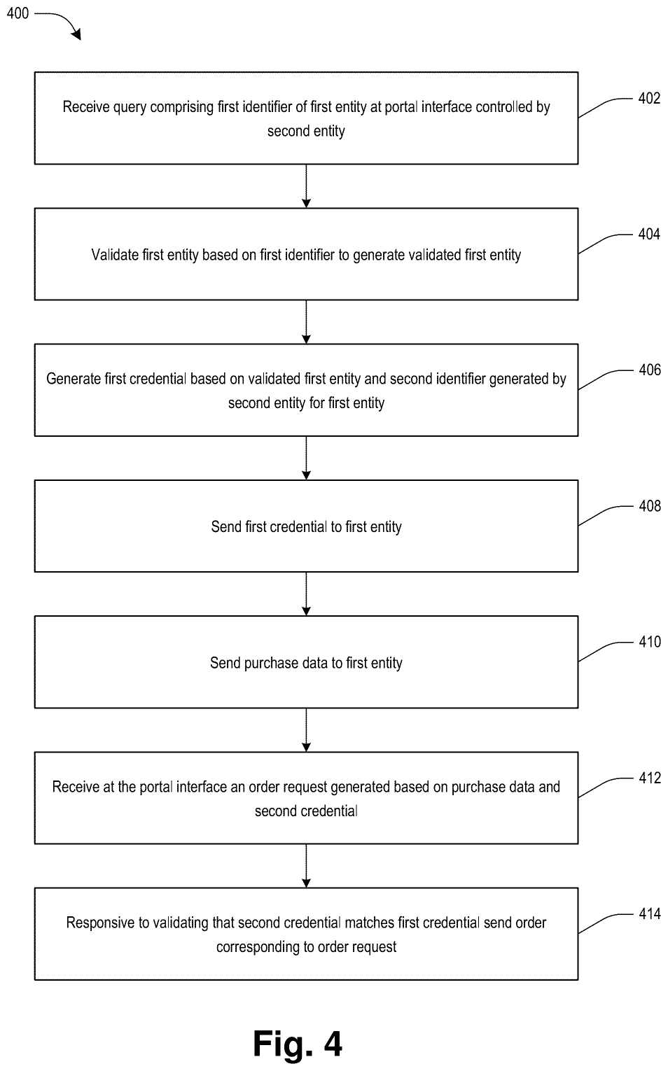

FIG. 4 is a flow chart illustrating an example method 400 for interfacing with service provider services through a portal interface 102, according to some embodiments. At 402, a query 208 is received at a portal interface 102. The query 208 includes a first identifier of a first entity, such as a customer entity. The portal interface 102 is controlled by a second entity, such as a service provider. At 404, the first entity is validated based on the first identifier to generate a validated first entity 210. At 406, a first credential is generated based on the validated first entity 210 and a second identifier generated by the second entity for the first entity. At 408, the first credential is sent to the first entity. At 410, service request data is sent to the first entity. At 412, an order request 214 associated with the service request data and a second credential is received at the portal interface 102. At 414, responsive to validating that the second credential matches the first credential, an order response corresponding to the order request is sent by the portal interface 102 to the user.

The portal interface 102 provides flexibility, security, and configuration control for the service provider. The service provider can make changes to the application domain 114 without losing connectivity with existing systems, such as a web portal 108, which have not been updated. Security is enhanced by using the time limited credential and encryption/decryption services for communicating link addresses and the credential.

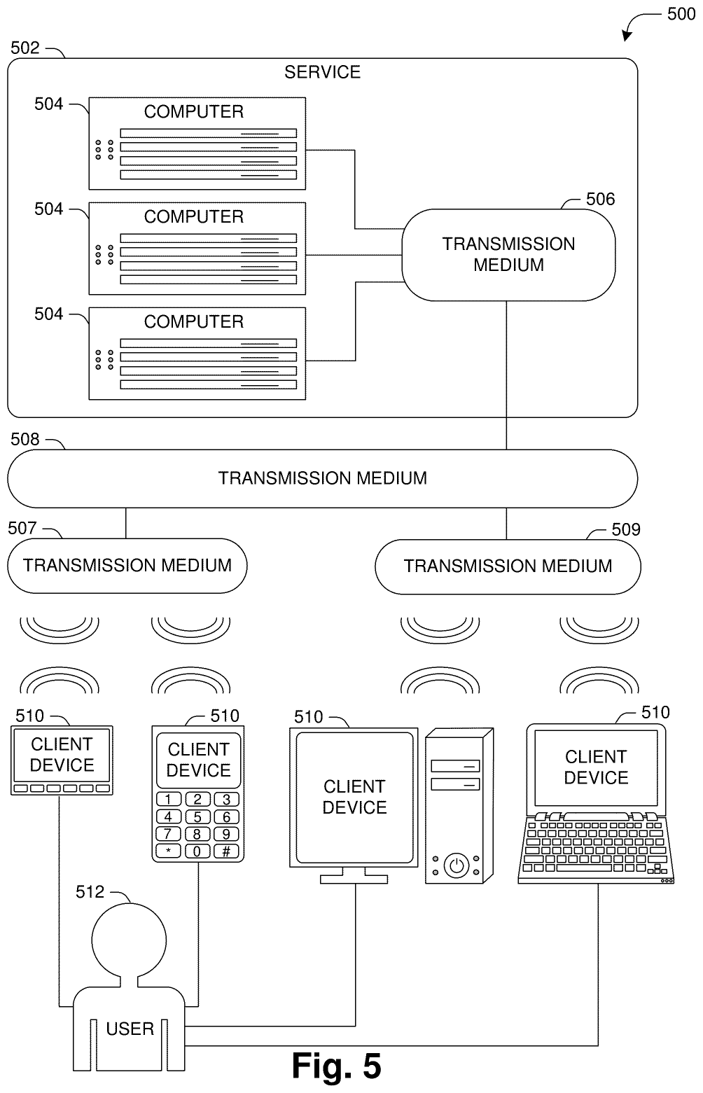

FIG. 5 is an interaction diagram of a scenario 500 illustrating a service 502 provided by a set of computers 504 to a set of client devices 510 via various types of transmission mediums. The computers 504 and/or client devices 510 may be capable of transmitting, receiving, processing, and/or storing many types of signals, such as in memory as physical memory states.

The computers 504 of the service 502 may be communicatively coupled together, such as for exchange of communications using a transmission medium 506. The transmission medium 506 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 502.

Likewise, the transmission medium 506 may comprise one or more sub-networks, such as may employ different architectures, may be compliant or compatible with differing protocols and/or may interoperate within the transmission medium 506. Additionally, various types of transmission medium 506 may be interconnected (e.g., a router may provide a link between otherwise separate and independent transmission medium 506).

In scenario 500 of FIG. 5, the transmission medium 506 of the service 502 is connected to a transmission medium 508 that allows the service 502 to exchange data with other services 502 and/or client devices 510. The transmission medium 508 may encompass various combinations of devices with varying levels of distribution and exposure, such as a public wide-area network and/or a private network (e.g., a virtual private network (VPN) of a distributed enterprise).

In the scenario 500 of FIG. 5, the service 502 may be accessed via the transmission medium 508 by a user 512 of one or more client devices 510, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 510 may communicate with the service 502 via various communicative couplings to the transmission medium 508. As a first such example, one or more client devices 510 may comprise a cellular communicator and may communicate with the service 502 by connecting to the transmission medium 508 via a transmission medium 507 provided by a cellular provider. As a second such example, one or more client devices 510 may communicate with the service 502 by connecting to the transmission medium 508 via a transmission medium 509 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 504 and the client devices 510 may communicate over various types of transmission mediums.

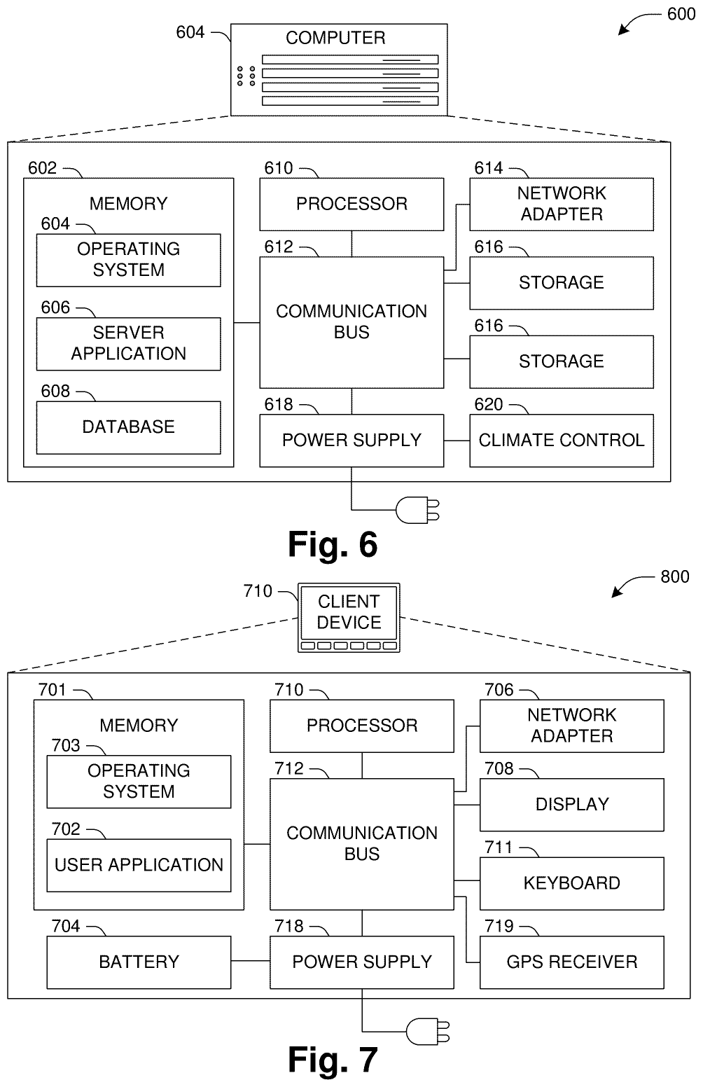

FIG. 6 presents a schematic architecture diagram 600 of a computer 604 that may utilize at least a portion of the techniques provided herein. Such a computer 604 may vary widely in configuration or capabilities, alone or in conjunction with other computers, in order to provide a service such as the service 502.

The computer 604 may comprise one or more processors 610 that process instructions. The one or more processors 610 may optionally include a plurality of cores; one or more coprocessors, such as a mathematics coprocessor or an integrated graphical processing unit (GPU); and/or one or more layers of local cache memory. The computer 504 may comprise memory 602 storing various forms of applications, such as an operating system 604; one or more computer applications 606; and/or various forms of data, such as a database 608 or a file system. The computer 604 may comprise a variety of peripheral components, such as a wired and/or wireless network adapter 614 connectible to a local area network and/or wide area network; one or more storage components 616, such as a hard disk drive, a solid-state storage device (SSD), a flash memory device, and/or a magnetic and/or optical disk reader.

The computer 604 may comprise a mainboard featuring one or more communication buses 612 that interconnect the processor 610, the memory 602, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 612 may interconnect the computer 604 with at least one other computer. Other components that may optionally be included with the computer 604 (though not shown in the schematic architecture diagram 600 of FIG. 6) include a display; a display adapter, such as a graphical processing unit (GPU); input peripherals, such as a keyboard and/or mouse; and a flash memory device that may store a basic input/output system (BIOS) routine that facilitates booting the computer 604 to a state of readiness.

The computer 604 may operate in various physical enclosures, such as a desktop or tower, and/or may be integrated with a display as an “all-in-one” device. The computer 604 may be mounted horizontally and/or in a cabinet or rack, and/or may simply comprise an interconnected set of components. The computer 604 may comprise a dedicated and/or shared power supply 618 that supplies and/or regulates power for the other components. The computer 604 may provide power to and/or receive power from another computer and/or other devices. The computer 604 may comprise a shared and/or dedicated climate control unit 620 that regulates climate properties, such as temperature, humidity, and/or airflow. Many such computers 604 may be configured and/or adapted to utilize at least a portion of the techniques presented herein.

FIG. 7 presents a schematic architecture diagram 700 of a client device 710 whereupon at least a portion of the techniques presented herein may be implemented. Such a client device 710 may vary widely in configuration or capabilities, in order to provide a variety of functionality to a user such as the user 512. The client device 710 may be provided in a variety of form factors, such as a desktop or tower workstation; an “all-in-one” device integrated with a display 708; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 709 that process instructions. The one or more processors 709 may optionally include a plurality of cores; one or more coprocessors, such as a mathematics coprocessor or an integrated graphical processing unit (GPU); and/or one or more layers of local cache memory. The client device 710 may comprise memory 701 storing various forms of applications, such as an operating system 703; one or more user applications 702, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 706 connectible to a local area network and/or wide area network; one or more output components, such as a display 708 coupled with a display adapter (optionally including a graphical processing unit (GPU)), a sound adapter coupled with a speaker, and/or a printer; input devices for receiving input from the user, such as a keyboard 711, a mouse, a microphone, a camera, and/or a touch-sensitive component of the display 708; and/or environmental sensors, such as a global positioning system (GPS) receiver 719 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 700 of FIG. 7) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 712 that interconnect the processor 709, the memory 701, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 718 that supplies and/or regulates power for other components, and/or a battery 704 that stores power for use while the client device 710 is not connected to a power source via the power supply 718. The client device 710 may provide power to and/or receive power from other client devices.

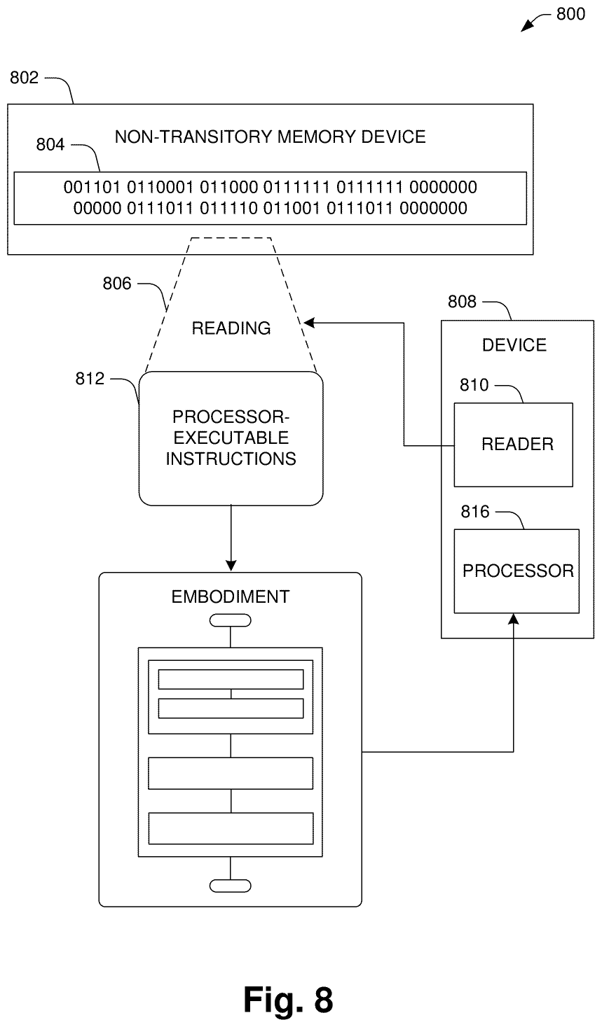

FIG. 8 is an illustration of a scenario 800 involving an example non-transitory machine-readable medium 802. The non-transitory machine readable medium 802 may comprise processor-executable instructions 812 that when executed by a processor 816 cause performance (e.g., by the processor 816) of at least some of the provisions herein. The non-transitory machine readable medium 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 802 stores machine-readable data 804 that, when subjected to reading 806 by a reader 810 of a device 808 (e.g., a read head of a hard disk drive, or a read operation invoked on a solid-state storage device), express the processor-executable instructions 812. In some embodiments, the processor-executable instructions 812, when executed cause performance of operations, such as at least some of the example method 400 of FIG. 4, for example. In some embodiments, the processor-executable instructions 812 are configured to cause implementation of a system.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
receiving a query comprising a first identifier of a first entity at a portal interface controlled by a second entity;
validating the first entity based on the first identifier to generate a validated first entity;
generating a first credential based on the validated first entity and a second identifier generated by the second entity for the first entity;
sending the first credential to the first entity;
sending service request data to the first entity;
receiving at the portal interface an order request associated with the service request data and a second credential at the portal interface; and
responsive to validating that the second credential matches the first credential, sending an order response corresponding to the order request.

2. The method of claim 1, wherein:
sending the first credential comprises encrypting the first credential; and
validating that the second credential matches the first credential comprises decrypting the second credential.

3. The method of claim 1, wherein sending the service request data comprises:
sending a link address to a list of available services.

4. The method of claim 1, wherein:
the query comprises a first address; and
the method comprises:
mapping the first address to a second address; and
forwarding the query from the portal interface to the second address.

5. The method of claim 1, wherein generating the first credential based on the validated first entity comprises:
generating the first credential based on at least one of a public business identifier or a network identifier associated with the validated first entity.

6. The method of claim 1, wherein:
the query comprises a query type; and
validating the first entity based on the validated first entity comprises validating that the first entity is authorized for the query type based on the validated first entity.

7. The method of claim 1, comprising:
invalidating the first credential after a predetermined time period, and
rejecting the order request responsive to receiving the order request after invalidating the first credential.

8. The method of claim 1, comprising:
receiving a second query at the portal interface from a third entity using an authenticated interface;
sending second service request data to the third entity;
receiving at the portal interface an order request associated with the second service request data; and
sending an order response corresponding to the order request.

9. A communication system, comprising:
a portal interface, comprising:
a routing module configured to receive a query comprising a first identifier of a first entity;
a validation module configured to validate the first entity based on the first identifier to generate a validated first entity; and
a credential generation module configured to generate a first credential based on the validated first entity and a second identifier generated by a second entity for the first entity,
wherein:
the routing module is configured to send the first credential to the first entity, send service request data to the first entity, and receive at the portal interface an order request associated with the service request data and a second credential at the portal interface,
the credential generation module is configured to validate that the second credential matches the first credential, and
the routing module is configured to, responsive to the credential generation module validating that the second credential matches the first credential, send an order response corresponding to the order request.

10. The communication system of claim 9, comprising:
a security module configured to encrypt the first credential prior to the routing module sending the first credential and decrypt the second credential prior to the credential generation module validating that the second credential matches the first credential.

11. The communication system of claim 9, wherein:
the service request data comprises a link address to a list of available services.

12. The communication system of claim 11, comprising:
a security module configured to encrypt the link address prior to the routing module sending the service request data to the first entity.

13. The communication system of claim 9, wherein:
the routing module is configured to map a first address in the query to a second address, and forward the query to the second address.

14. The communication system of claim 9, wherein:
the credential generation module is configured to generate the first credential based on at least one of a public business identifier or a network identifier associated with the validated first entity.

15. The communication system of claim 9, wherein:
the query comprises a query type; and
the validation module is configured to validate that the first entity is authorized for the query type based on the validated first entity.

16. The communication system of claim 9, wherein:
the credential generation module is configured to invalidate the first credential after a predetermined time period, and reject the order request responsive to receiving the order request after invalidating the first credential.

17. A non-transitory computer-readable medium storing instructions thereon that when executed by a processor cause the processor to:
receive a query comprising a first identifier of a first entity at a portal interface controlled by a second entity;
validate the first entity based on the first identifier to generate a validated first entity;
generate a first credential based on the validated first entity and a second identifier generated by the second entity for the first entity;
send the first credential to the first entity;
send service request data to the first entity;
receive at the portal interface an order request generated based on the service request data and a second credential at the portal interface; and
responsive to validating that the second credential matches the first credential, send an order response corresponding to the order request.

18. The medium of claim 17, wherein the processor is to:
send the service request data by sending a link address to a list of available services.

19. The medium of claim 17, wherein the processor is to:
map a first address in the query to a second address; and
forward the query from the portal interface to the second address.

20. The medium of claim 17, wherein the processor is to:
invalidate the first credential after a predetermined time period, and
reject the order request responsive to receiving the order request after invalidating the first credential.
